(19) United States
(12) Patent Application Publication
(10) Pub. No.: US 2015/0326688 A1
(43) Pub. Date: Nov. 12, 2015

(54) METHOD AND APPARATUS FOR PROVIDING SEGMENT-BASED RECOMMENDATIONS

(71) Applicant: NOKIA CORPORATION, Espoo (FI)

(72) Inventors: Ari AARNIO, Espoo (FI); Jilei TIAN, Beijing (CN); Yongguang GUO, Beijing (CN); Yujia XIA, Xi'an (CN); Laptim TSE, Hong Kong (CN)

(21) Appl. No.: 14/763,119

(22) PCT Filed: Jan. 29, 2013
(86) PCT No.: PCT/CN2013/071081

§ 371 Date: Jul. 23, 2015

(51) Int. Cl. H04L 29/08; G06F 17/30

(52) U.S. Cl. CPC H04L 67/30; G06F 17/30743

(57) ABSTRACT

An approach is provided for determining user profiles with respect to content items based on segments of the content items. In an example embodiment, a segment-based user profile platform determines rating information associated with one or more segments of one or more content items corresponding to at least one user, wherein the one or more segments are discrete portions of the one or more content items. The segment-based user profile platform further processes the rating information to determine at least one profile of the at least one user.

### BACKGROUND

Service providers and device manufacturers (e.g., wireless, cellular, etc.) are continually challenged to deliver value and convenience to consumers by, for example, providing compelling network services. Services with respect to recommending content items to users are becoming increasingly more important as service providers attempt to distinguish their services from competitors. Such services rely on learning users' preferences and behaviors with respect to content items to learn what additional content items to recommend to the users. These services rely on, for example, a user's rating with respect to an entire content item, such as an entire song, to determine what other songs the user may enjoy. However, the reasons that a user may enjoy one song may be more specific than the user enjoying the entire song. Accordingly, service providers and device manufacturers face significant technical challenges in providing services with respect to recommending content items to users.

### SOME EXAMPLE EMBODIMENTS

Therefore, there is a need for an approach for determining user profiles with respect to content items based on segments of the content items.

According to one embodiment, a method comprises determining rating information associated with one or more segments of one or more content items corresponding to at least one user, wherein the one or more segments are discrete portions of the one or more content items. The method also comprises processing the rating information to determine at least one user profile of the at least one user.

According to another embodiment, an apparatus comprises at least one processor, and at least one memory including computer program code for one or more computer programs, the at least one memory and the computer program code configured to, with the at least one processor, cause, at least in part, the apparatus to determine rating information associated with one or more segments of one or more content items corresponding to at least one user, wherein the one or more segments are discrete portions of the one or more content items. The apparatus is also caused to process the rating information to determine at least one user profile of the at least one user.

According to another embodiment, a computer-readable storage medium carries one or more sequences of one or more instructions which, when executed by one or more processors, cause, at least in part, an apparatus to determine rating information associated with one or more segments of one or more content items corresponding to at least one user, wherein the one or more segments are discrete portions of the one or more content items. The apparatus is also caused to process the rating information to determine at least one user profile of the at least one user.

According to another embodiment, an apparatus comprises means for determining rating information associated with one or more segments of one or more content items corresponding to at least one user, wherein the one or more segments are discrete portions of the one or more content items. The apparatus also comprises means for processing the rating information to determine at least one user profile of the at least one user.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining user profiles with respect to content items based on segments of the content items, according to one embodiment;

FIG. 2 is a diagram of the components of a segment-based user profile platform, according to one embodiment;

FIG. 3 is a flowchart of a process for determining user profiles with respect to content items based on segments of the content items, according to one embodiment;

FIG. 4 is a flowchart of a process for providing one or more recommendations of content items based on the user profiles and one or more segments of the content items, according to one embodiment;

FIG. 5 is a flowchart of a process for determining one or more segments of a content item, according to one embodiment;

FIGS. 6A-6L are diagrams of user interfaces utilized in the processes of FIGS. 3-5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for determining user profiles with respect to content items based on segments of the content items are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term content item refers to any item that may be consumed by a user, such as by a user listening to a content item, watching a content item, reading a content item, streaming a content item, etc. Although various embodiments are described with respect to a content item representing audio (e.g., songs), it is contemplated that the approach described herein may be used with other types of content items, such as videos, images, books, magazines, web pages, video games, applications, etc.

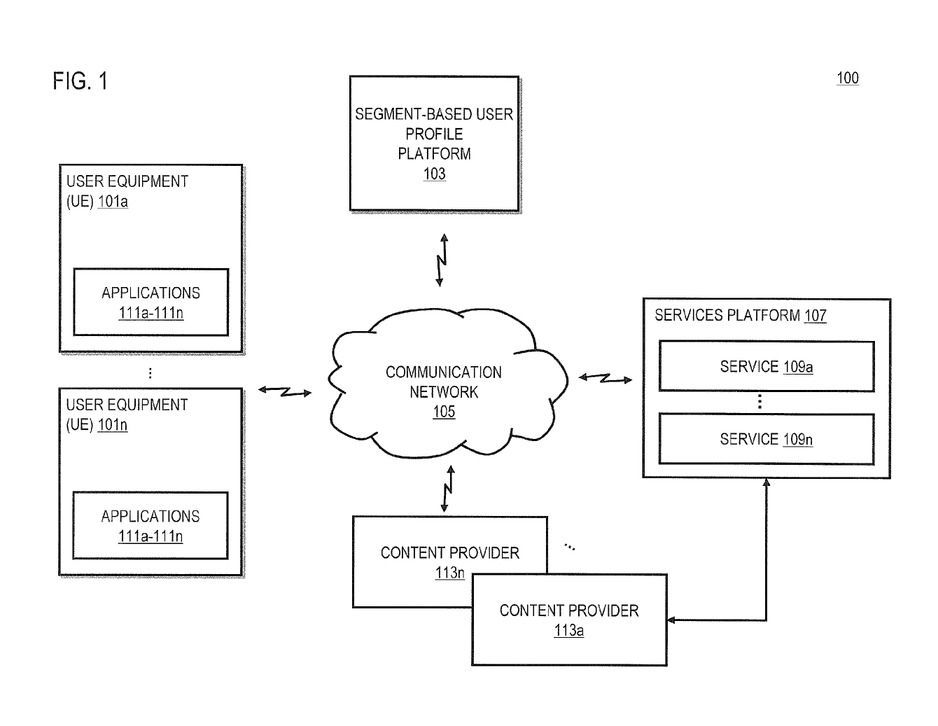

FIG. 1 is a diagram of a system 100 capable of determining user profiles with respect to content items based on segments of the content items, according to one embodiment. As discussed above, service providers and device manufacturers are focusing on the ability to recommend content items to users. The ability to recommend content items to users stems, at least in part, from the ability to determine preferences and/or behaviors of users and apply the preferences and/or behaviors to content items through recommendations. By way of example, music services are becoming increasingly popular with the advent of portable digital music players and mobile phones with the capability of playing music. Such music services generally have the capability of recommending one or more songs to a user based on one or more other songs the user may have, for example, purchased, downloaded, rated, etc. Thus, such services and the recommendations related to the services treat music songs or tracks as the basic unit for rating and recommending. However, users may often have different preferences to different portions of a song. Although the user may, for example, like one portion of the song, the user may have no opinion or dislike the remaining portion of the song. By way of example, a user may like the refrain or chorus of a song but dislike the verse. Further, different users may like the same song but for different reasons. By way of example, user A may enjoy a song because of the chorus but dislike the refrain, and user B may enjoy the same song because of the refrain but not have an opinion with respect to the chorus. However, current services cannot leverage this information because the song (e.g., content item) is treated as the basic unit.

Further, recommendation services sometimes allow users to consume a portion of content items to allow the users to determine if they like the content items. By way of example, music services generally provide the same short sample of a song for users to listen to so that the users may determine whether or not they enjoy the song. However, the same short sample of the song may not be enough for the users to make an accurate decision. The users may hear the portion of the song that they unknowingly dislike the most, while the remaining portion could potentially interest them such that the users could enjoy the song overall.

To address these problems, the system 100 of FIG. 1 introduces the capability to determine user profiles with respect to content items based on segments of the content items. By determining user profiles with respect to content items based on segments of the content items, the system 100 allows for more accurate representations of the user profiles with respect to what the user enjoys, what the user does not enjoy, and for what the user has no opinion. Using these more granular user profiles with respect to content items, the system 100 allows for more accurate recommendation services, more accurate generation of samples of content items for users to consume, improvements to user interfaces presenting the content items, and the like.

The system 100 may determine the user profiles by determining rating information associated with one or more segments of one or more content items corresponding to at least one user. The one or more segments are discrete portions of the one or more items. By way of example, for a song that is four minutes long, a segment of the song may be thirty seconds, sixty-two seconds, ninety-five seconds, etc. (e.g., not the entire length of the song). In one embodiment, the segment may be only a portion of the instruments that constitute the song, such as only the guitar while the drums and lyrics are removed. There may be any number of segments associated with the content items, such as two, three, five, ten, etc. Based on the rating information associated with the one or more segments, the system 100 can determine at least one user profile for the at least one user. Because the user profile is based on rating information that pertains to segments of the content items, rather than the content items as a whole, the user profile can more accurately represent the preferences of the user with respect to the characteristics, properties, etc. of the content items.

As shown in FIG. 1, the system 100 comprises user equipment (UE) 101a-101n (collectively referred to as UE 101) having connectivity to a segment-based user profile platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, near field communication (NFC), Internet Protocol (IP) data casting, digital radio/television broadcasting, satellite, mobile ad-hoc network (MANET), and the like, or any combination thereof.

The UE 101 is any type of mobile terminal, fixed terminal, or portable terminal including a mobile handset, station, unit, device, mobile communication device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The UE 101 may include one or more applications 111a-111n (collectively referred to as applications 111) that may include, for example, one or more multimedia applications, one or more multimedia streaming applications, one or more content item provisioning applications, one or more social networking applications, etc. In one embodiment, the functions and/or operations performed by the segment-based user profile platform 103 may be embodied, either in full or in part, by one or more of the applications 111. By way of example, a music player application 111a may allow for a user to play music. The segment-based user profile platform 103 may be embodied in the music player application 111a and/or be in communication with the music player application 111a such that the user may provide rating information with respect to one or more segments of a song being played by the music player application 111a, and the segment-based user profile platform 103 may provide one or more recommendations of content items and/or of segments of content items based on a user profile generated based on the user's ratings.

The system 100 may also include a services platform 107 that includes one or more services 109a-109n (collectively referred to as services 109). The services 109 may be any type of service, such as a content item distribution service (e.g., allows streaming and/or purchasing of music, images, video, etc.), a content item recommendation service, one or more social networking services, and the like. In one embodiment, the functions and/or operations performed by the segment-based user profile platform 103 may be embodied, either in full or in part, by one or more of the services 109. By way of example, a music provisioning service 109a may provide recommendations to users regarding music that the users may enjoy. The segment-based user profile platform 103 may be embodied in the music provisioning service 109a and/or be in communication with the music provisioning service 109a to provide one or more recommendations regarding what music the user may enjoy based on a user profile associated with the user that is generated based on rating information of one or more segments provided by the user.

The system 100 may also include one or more content providers 113a-113n (collectively referred to as content providers 113). The content providers 113 may provide content, such as content items, to one or more elements of the system 100. By way of example, the content providers 113 may provide content items, such as songs, videos, movies, etc., to the UE 101 in response to one or more operations associated with the users of the UE 101 purchasing, streaming and/or downloading one or more content items from one or more services 109 in response to one or more recommendations made based on the user profile generated by the segment-based user profile platform 103.

A segment of a content item may have more distinct properties and/or characteristics than the content item as a whole. The segment-based user profile platform 103 can take advantage of the more distinct features so that the segment-based user profile platform 103 can provide more accurate analysis with respect to the content items, such as providing more accurate recommendations to users for content items based on user profiles determined according to rating information of segments, and provide improvements to user interfaces, such as by displaying information regarding the content items according to the segments rather than for the entire content items. By way of example, the segment-based user profile platform 103 can learn user rating information at the segment level of music and, therefore, recommend the music based on the segment level. In one embodiment, the segment-based user profile platform 103 may recommend a segment level music playlist where each song within the playlist is a segment of a song rather than the entire song. In this example, the user may enjoy the music in a more efficient manner by focusing on the most preferred part and ignoring the least preferred part. This segment-based approach may be applied to various content items, such as streaming music services. The streamed music may be segmented so that the user may enjoy the most preferred portions of the streamed music.

The segment-based user profile platform 103 may determine a user profile by modeling the properties and/or characteristics of the segments of the content items that a user provided ratings on. In one embodiment, the segment-based user profile platform 103 can apply a principle component analysis (PCA) to extract Eigen taste clips to generate a user profile. The Eigen taste clips provide latent factors with respect to patterns in the content items, such as acoustic patterns for songs. The user and individual content items may be represented by Eigen clip distributions in an Eigen clip space with ratings.

Upon determining a user profile for a user based on rating information with respect to one or more segments of one or more content items, the segment-based user profile platform 103 may process one or more other content items based on the user profile to determine one or more other segments of the one or more other content items, or the one or more other content items themselves, that the user may also like and/or dislike. Where, for example, the user enjoys classic rock songs with long guitar solos, the segment-based user profile platform 103 can process other songs to determine if the other songs have long guitar solos. Further, by way of example, where a user enjoys movies with action scenes involving a lot of explosions, the segment-based user profile platform 103 can process other movies to determine if the other movies have similar action scenes. Based on processing one or more other content items, the segment-based user profile platform 103 can determine one or more recommendations of the one or more other content items based on the one or more other segments of the one or more other content items. For example, the segment-based user profile platform 103 can recommend the other songs with long guitar solos and the other movies with action scenes even if the entirety of the songs and/or movies do not match the preferences and/or qualities the user normally likes in a song and/or movie.

In one embodiment, the segment-based user profile platform 103 may segment the content items based on one or more approaches. In one embodiment, the segment-based user profile platform 103 may provide an automatic segmentation. The segment-based user profile platform 103 may segment the content items based on analyzing properties and/or characteristics of the content items. By way of example, where the content item is a song, the segment-based user profile platform 103 may perform an acoustic analysis of the song to determine the chorus, refrain, etc. of the song and segment the song accordingly. The segment-based user profile platform 103 may also segment a song based on features of the song, such as guitar solos, vocal solos, etc. Where the content item is a movie, for example, the segment-based user profile platform 103 may segment the movie based on one or more of the audio and video of the movie. By way of example, the segment-based user profile platform 103 may segment the movie according to scenes that are determined based on changes in light, colors, etc. that may reveal a change in scenery. The segment-based user profile platform 103 may also segment the movie based on changes in the soundtrack and/or special effects. Thus, however the segmentation occurs, the segment-based user profile platform 103 may automatically generate segments of the content items.

Further, where the segment-based user profile platform 103 automatically generates the segments of the content items based on an analysis of the content items, the segment-based user profile platform 103 may store information pertaining to the segments and the analysis of the segments, such as how and/or why the segments where generated. The information associated with the segments allows for the segment-based user profile platform 103 to generate segment profiles with respect to the segments of the content items. For example, if the segment-based user profile platform 103 generated a segment based on a guitar solo within a song, the segment-based user profile platform 103 may classify the segment as a solo, associate the segment with a guitar, classify the segment as in the genre of rock and roll, etc. This information may be used to generate a segment profile so that rating information provided by one or more users with respect to the segment may be associated with specifics of the segment that may have been the reason for the rating. For example, a high rating for a segment may be because the user likes guitar solos, as discussed above.

In one embodiment, the segment-based user profile platform 103 may segment content items based solely on user input. One or more user inputs may indicate a beginning, an ending, and/or a span of a segment. By way of example, a user may provide an input, such as clicking a button, that indicates the beginning of a segment. The user may click the same button or another button to indicate the ending of the segment. In one embodiment, the user may click and hold a button to indicate the beginning of a segment and may release the button to indicate the ending of the segment. The input may be associated with a physical button, such as a mouse button, a keyboard button, etc., or may be associated with a visual button (e.g., an icon) presented within a user interface of an application, such as a music player application 111a, that is selected with a cursor (e.g., mouse) or through a touch-sensitive interface (e.g., touch screen). Thus, the user may manually segment the content items based on the one or more inputs.

When the user indicates a segment of a content item, the segment-based user profile platform 103 may subsequently perform analysis with respect to the segment, such as acoustic analysis with respect to a segment of a song, to determine one or more properties and/or characteristics of the segment. Related to the example above, a user may generate a segment of a song by indicating the beginning and ending of, for example, a guitar solo. Upon analyzing the segment, the segment-based user profile platform 103 may determine that the segment is associated with a solo of a guitar for a song in the genre of rock and roll. The segment-based user profile platform 103 may then assign the determined characteristics and/or properties to the segment of the content item so that rating information provided by one or more users with respect to the segment may be associated with the characteristics and/pr properties of the segment that may have been the reason for the rating. For example, a high rating for a segment may be because the user likes guitar solos, as discussed above.

In one embodiment, the indication of the one or more segments may be linked to indicating rating information with respect to the segments. The one or more inputs may be associated with indicating a rating of the segment that is being generated. For example, the user may click a like button while listening to a song to indicate that the user likes the portion of the song that is playing. The input of clicking the like button can both indicate that the user likes the portion of the song that is playing and begin creating a segment of the song. Once the user clicks the like button again or releases the like button, for example, the segment-based user profile platform 103 may determine the ending of the segment. The input may also be associated with indicating a dislike of the segment that is generated. For example, the user may click a dislike button to indicate a beginning of a segment that the user dislikes and click the dislike button again (or release the dislike button) to indicate the ending of the segment.

In one embodiment, upon selecting the button or icon to indicate a like/dislike, the button or icon may change to indicate activity associated with segmenting the content item and/or providing rating information. By way of example, upon a user selecting a star icon to indicate rating information and/or segmenting a content item, the star may change colors or start blinking to indicate that the rating and/or segmenting is active. The rating and/or segmenting will apply to the current portion of the content item that is playing. Upon the user selecting the star icon again, the star icon can return to the previous color or stop blinking to indicate that the rating and/or segmenting is no longer active.

The input may be associated with any type of rating, such as like/dislike. Where the input is associated with a visual icon presented at the user interface, the icon may be represented by, for example, a smiley face, a frowning face, a heart, a thumbs-up, a thumbs-down, etc. The input may also provide more granularity with respect to the rating information than just like/dislike, such as how much the user likes and/or dislikes the segment. By way of example, there may be multiple stars to indicate the rating information, with each star indicating that the user likes the segment more, there may be a sliding scale, an input box to allow a number (e.g., between 1 and 100), and the like.

In one embodiment, upon the user indicating a like or dislike of a segment of a content item another menu may appear to allow the user to enter more granular information regarding the user's likes/dislikes with respect to the segment of the content item. By way of example, as a user is consuming a content item (e.g., listening to a song, playing a game, etc.), the user may determine that he or she does not like the segment of the content item. For example, the user may determine that he or she does not like the current portion of a song that is playing. In response, the user may select to hear the next song, such as by selecting a forward button. The selection of the forward button may trigger another menu to provide more detailed rating information, such as opening a menu with hearts and/or stars to rate the segment of the content item. In one embodiment, the menu may include questions, such as do you like the portion of the song that was playing, etc. Depending on the answers to the questions, the user may be provided with more questions. Following responding to the menu, the user may be presented with other content items that the segment-based user profile platform 103 recommends based on the user's profile. The recommendation may be made on the fly based on the answers the user provided in response to the menu, such as the answers the user provided in response to the questions. In one embodiment, the menu is only presented to the user in the event that the user indicates a dislike (e.g., such as by forwarding or skipping) a content item or a segment of a content item that the segment-based user profile platform 103 originally recommended. The menu may be provided to obtain additional rating information that may be used to modify the user's profile to avoid recommending similar content items or segments of content items in the future.

In one embodiment, the user may select, for example, the progress bar associated with playback of a song to indicate one or more segments of the song that the user likes/dislikes. The user may use a cursor (e.g., mouse cursor) or other input (e.g., finger on a touch screen) to swipe or highlight the progress bar to segment the content item and/or select one or more segments of the song that the user likes/dislikes. For example, a user may move the cursor to minute two of a song and click and drag the cursor to minute three of the song to indicate that the user likes the segment of the song between minutes two and three. By way of another example, the user may glide his or her finger along the length of the progress bar of a song indicating the segment of the song that the user likes.

Alternatively, the user may select an icon, such as a star, a heart, or the like, and drag the icon over the progress bar to indicate one or more segments of the content item and/or provide rating information with respect to one or more segments. By way of example, a paint brush icon may be associated with the user interface. The user may select the paintbrush icon to then swipe across, for example, a progress bar associated with a content item to segment the content item and/or provide rating information associated with segments of the content item. In one embodiment, a user may paint a segment of the progress bar and then listen to the segment that is created. The user may then refine the segment by editing the painted portion after listening to the segment.

In one embodiment, there may be a time lag between a user determining that he or she likes or dislikes the content item while consuming the content item and providing one or more inputs associated with indicating the like or dislike. In this embodiment, the segment-based user profile platform 103 may mark the beginning of the segment as occurring a threshold period of time prior to receiving the input. By way of example, a user may indicate that he or she likes a segment of a song that is playing ten seconds into the hearing the segment that the user likes. Upon the user performing one or more inputs, the segment-based user profile platform 103 may indicate that the segment began ten seconds prior to the input. The threshold may be any length of time (e.g., one second, five seconds, one minute, etc.) and may be set by the user, may be automatically set, or both.

Although the above inputs are described as being related to clicking a button (physical or graphical), the input may be associated with other interactions, such as voice-based input, and/or gesture-based input. The gesture-based input may be visually based, such as a camera capturing one or more movements, changes in posture, facial expressions, etc., or may be physically based, such as one or more accelerometers detecting a user shaking their hand, nodding their head, etc.

In one embodiment, the segment-based user profile platform 103 may rely on both automatic and manual segmentation to segment content items. For example, the segment-based user profile platform 103 may initially segment a song according to an acoustic analysis of the song. In addition to these segments, a user may indicate other segments of the song through one or more inputs. The one or more segments generated by the user may span one or more segments automatically generated by the segment-based user profile platform 103 or may be within a single segment generated by the segment-based user profile platform 103.

Further, in one embodiment, the segment-based user profile platform 103 may rely on socially based segmentation. For example, one or more users that belong to a social network and/or are associated with the segment-based user profile platform 103 or a service 109a that is associated with the segment-based user profile platform 103 may manually segment a content item. The segments generated by the user may be similar or dissimilar. Based on the segmentation of the other users, the segment-based user profile platform 103 may determine default segments of the content items. When providing the content item to a new user, the segment-based user profile platform 103 may provide the content item pre-segmented based on the segments determined by the multiple users. The user may then rely on the previously determined segments or generate his or her own segments of the content item to provide rating information.

As the user provides rating information with respect to segments of content items, whether the segments were created manually and/or automatically, the segment-based user profile platform 103 may cause the user interface with respect to the content item to change to indicate the rating information. By way of example, as a user is listening to a song and providing rating information, the rating information may appear within the user interface, such as by changing the color of segments of the progress bar of the song where different colors correspond to different ratings, providing stars above the progress bar of the song where different numbers of stars correspond to different ratings, etc. The rating information may appear in the progress bar as the user provides the rating information. Further, in the case discussed above where the segmentation of a content item occurs, at least in part, based on input from one or more other users (e.g., social segmentation), the rating information may appear in the user interface associated presenting the content item based on the segments for a new user. By way of example for a song, the progress bar of the song may include different colors indicating the rating information of the various users that socially segmented the song. In one embodiment, a user selecting a portion of the progress bar may provide additional information with respect to the rating information, such as names of users that provided the rating information, percentage of the average rating of the selected portion of the song, etc.

In one embodiment, following a user providing rating information with respect to one or more segments of content items, the segment-based user profile platform 103 can cause one or more functions and/or operations with respect to the user consuming the content item based on the one or more segments. By way of example, for a song or a movie, the segment-based user profile platform 103 can cause playback of the song or the movie to begin from the beginning of one or more of the segments, such as the first segment marked as liked, or from the highest rated segment for the user.

Similarly, in view of the user profile that is generated based on the rating information of one or more segments of one or more content items, the segment-based user profile platform 103 can determine and/or generate one or more segments of one or more content items for previewing the one or more content items and/or one or more other content items. By way of example, music provisioning services generally allow users to listen to a preview of a song, such as a short portion of the song. Traditionally, the short portion of the song is standard for all users and does not necessarily reflect the entire properties and/or characteristics of the song. By determining the user profile, the segment-based user profile platform 103 introduces the ability to determine segments of songs specific to a user and provide the specific segments to the user for previewing the content items. The segment may be the part of the content item that most closely matches the properties and/or characteristics associated with segments of content items that the user previously provided ratings for. Thus, by previewing the personalized segments, the user can quickly determine whether or not the user will like the content items. The segment-based user profile platform 103 may also allow presenting multiple segments of the content items and provide information within a user interface regarding the segments, such as characteristics and/or properties of the segments, to allow the user to select the segment to listen to for a preview of the content item. In one embodiment, the user may swipe a cursor and/or finger across a progress bar indicating that the user likes the segment of the content item associated with the segment of the progress bar that is swiped. In response, the segment-based user profile platform 103 may determine one or more segments of one or more other content items that match characteristics and/or properties of the swiped portion.

In one embodiment, the segment-based user profile platform 103 may determine one or more recommended segments of one or more content items that the user is currently consuming and provide one or more indications with respect to the one or more recommended segments within the user interface and use the one or more recommended segments to further update the user profile. The segment-based user profile platform 103 may further determine predicted rating information associated with the one or more recommended segments based on the user profile. While the user is consuming the content items, the user may comprehend what part of the content items he or she may enjoy the most based on the presented one or more recommended segments, in addition to the predicted rating information for the one or more recommended segments, and preview or consume the recommended segments. Upon previewing or consuming the recommended segments, the user may then provide rating information with respect to the one or more recommended segments. In one embodiment, the user may provide the rating information by adjusting or confirming the predicted rating information for the one or more recommended segments. The rating information or the mere presentation of the recommended segments may be used to further determine the user profile.

By way of example, while listening to a song, the user interface associated with the music application 111a may indicate one or more segments of the song as recommended segments. For example, one or more segments of a progress bar may be highlighted indicating that the user may like the highlighted segments or suggesting the segments to the user. The segment-based user profile platform 103 may further cause the music application 111a to inquire whether the user would like to immediately listen to the recommended segments. If the user chooses to immediately listen to the segments, or listens to the segments as they are reached within playback of the song, the user may then provide rating information with respect to the recommended segments. The additional rating information and/or that the one or more recommended segments were presented or recommended to the user may be further used in determining the user profile associated with the user.

In one embodiment, the segment-based user profile platform 103 allows for tagging of the content items based on the one or more segments. Thus, in addition to providing rating information for content items based on one or more segments, tagging of the content items may be performed at the segment level. Where the content items are songs, for a single song, different segments corresponding to different styles, genres or characteristics may be assigned to the different segments. Where the segment-based user profile platform 103 automatically generates the segments of the content items, the segment-based user profile platform 103 may also automatically tag the segments based on the characteristics and/or properties of the segments that constitute the segment profile. Where the user determines the segments of the content items, the segment-based user profile platform 103 may allow the user to tag the segments based on one or more inputs from the user, such as one or more descriptions of the segments. Further, where the segment-based user profile platform 103 processes the segments determined by the user, the segment-based user profile platform 103 may subsequently tag the segments with the characteristics and/or properties that the segment-based user profile platform 103 determines for the segments. Thus, the resulting tags may be more accurate than tagging an entire content item without distinguishing the different styles, genres or characteristics.

By way of example, the UE 101, the segment-based user profile platform 103, the services platform 107 and the content providers 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

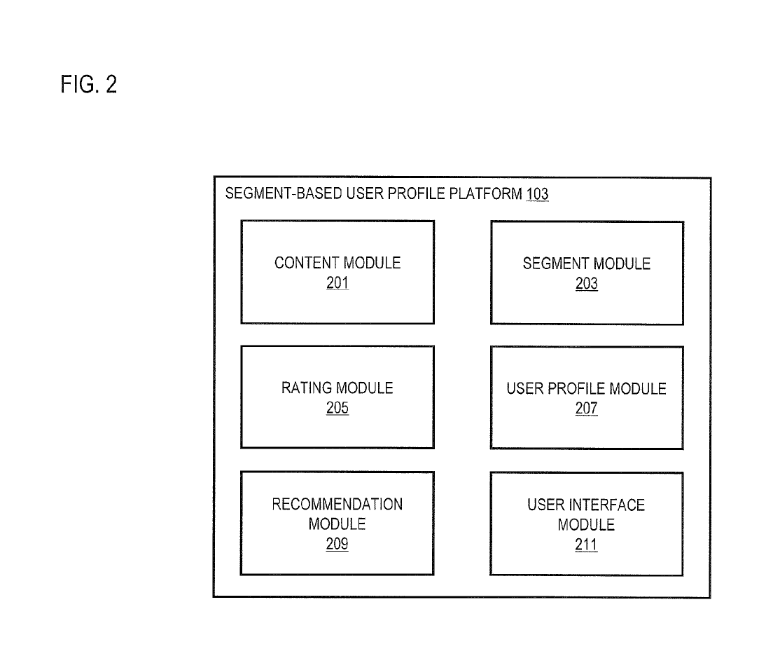

FIG. 2 is a diagram of the components of a segment-based user profile platform 103, according to one embodiment. By way of example, the segment-based user profile platform 103 includes one or more components for determining user profiles with respect to content items based on segments of the content items. It is contemplated that the functions of these components may be combined in one or more components or performed by other components of equivalent functionality, such as discussed above embodied in one or more applications 111 and/or services 109. In this embodiment, the segment-based user profile platform 103 includes a content module 201, a segment module 203, a rating module 205, a user profile module 207, a recommendation module 209 and a user interface module 211.

The content module 201 may track information with respect to the various content items for which the segment-based user profile platform 103 determines rating information and segmentation information for. As discussed above, the content items may include, for example, songs, movies, videos, images, books, magazines, or any content item that a user can consume, such as by consuming visuals and/or audio associated with the content items.

The segment module 203 determines the segments of the content items. In one embodiment, the segment module 203 determines the segments of the content items automatically by analyzing the content items. Where, for example, the content items are songs, the segment module 203 may perform acoustic analysis of the songs to determine various segments in the audio based on, for example, changes in pitch, tempo, beats per minute, etc. The acoustic analysis may also involve analysis with respect to lyrics in the songs, such as determining the refrain and the chorus of the songs.

In one embodiment, the segment module 203 determines the segments of the content items based on one or more user inputs. As discussed above, users may manually enter information regarding the segments of the content items. In one embodiment, the users entering rating information also defines segments of the content items. For example, a user performing an input, such as clicking a like button, may mark the beginning of a segment of the content item. The user performing another input, such as clicking the like button again, clicking a dislike button, or releasing the like button, may indicate the ending of the segment. However, the one or more user inputs may be any type of input that can be determined by the segment module 203, such as audio input (e.g., voice commands), visual input (e.g., one or more gestures), tactile input (e.g., movements detected by an accelerometer), and the like.

Further, as discussed above, in one embodiment the segment-based user profile platform 103 by way of the segment module 203 may determine segments of the content items based on both automatic segmentation according to analyzing the content items, as well as manual segmentation performed by users. Thus, in one embodiment, a user may further define and/or refine segments of the content items by creating one or more manually entered segments that overlap or span two or more automatically generated segments or that are within an automatically generated segment. Further, in one embodiment, the segment module 203 allows for crowd sourcing for generating one or more segments of content items. For example, one or more users may manually create one or more segments of the content items, which may be averaged and/or normalized to create one or more default segments of the content items.

The rating module 205 determines rating information with respect to one or more segments of one or more content items through one or more ratings provided by a user. That rating information may be acquired in any way that allows for a user providing information with respect to his or her preferences and with respect to a content item, including indicating that the user likes and dislikes the content items. Further, the rating module 205 allows for various granularities of the rating information, such as the least granular like/dislike, to a greater granularity of, for example, rating segments on a scale of 1 to 100.

In one embodiment, the rating module 205 also accepts tagging information that can be specific to one or more segments of content items. The tagging information may include, for example, information with respect to a style, genre, artist, album, characteristics, etc. that pertain to the segments of the one or more content items.

The user profile module 207 determines the user profiles with respect to content items based on the rating information with respect to one or more segments of the content items. The user profile module 207 processes rating information that a user provides with respect to one or more segments of content items to build the user profile for the user. Because the user profile is generated based on one or more segments of content items rather than content items as a whole, the user profile module 207 is able to generate a user profile that more closely correlates a user's preferences with respect to content items to the portions of the content items that a user likes and/or dislikes. The ability for the user profile module 207 to accommodate both likes and dislikes within a single content item based on one or more segments of the content item allows for a greater ability to tailor content the content items for the user.

The user profile module 207 may learn a user's profile by modeling the collected rating information of segments of content items. In one embodiment, the modeling may be based on a principle component analysis to extract Eigen taste clips with respect to a user's profile. The user profile module 207 may generate user eigen clip rating matrices for the users and eigen clip matrices for the content items, where the matrices may include one or more latent factors that describe qualities and/or characteristics of the content items. The user profile module 207 may perform an analysis with respect to the matrices and latent factors to determine the user profiles that describe the preferences of the user.

In one embodiment, a similar analysis may be performed by the content module 201 with respect to the content items based on a combination of the user profiles of users that provide rating information with respect to segments of content items and/or based on compiled rating information. The one or more segments of the content items may be further defined with respect to, for example, qualities and/or characteristics of the segments to provide a better understanding of the qualities and/or characteristics of the content items. By way of example, the content module 201 may perform a collaborative filtering by processing the Eigen taste clips as tags to model the content items in a common content items space. Where modeling shows patterns associated with characteristics and/or properties of content items according to, for example, multiple users, those characteristics and/or principles may be added to the segments of the content items.

The recommendation module 209 provides one or more recommendations with respect to content items based on the segments of the content items and the user profiles determined by the user profile module 207. By way of example, the recommendation module 209 may determine one or more recommendations for songs a user may enjoy based on the segments of the songs and the user profile, which includes rating information of one or more segments of songs for which the user provided ratings. The recommendation module 209 may recommend the entire song or, in one embodiment, recommend and provide segments of the songs. Thus, in one embodiment, the recommendation module 209 may generate one or more segments of content items to present to the user. As such, a user can listen to, for example, a short segment of a song that is selected for the user based on the user profile rather than listening to a generic segment or having to listen to the entire song.

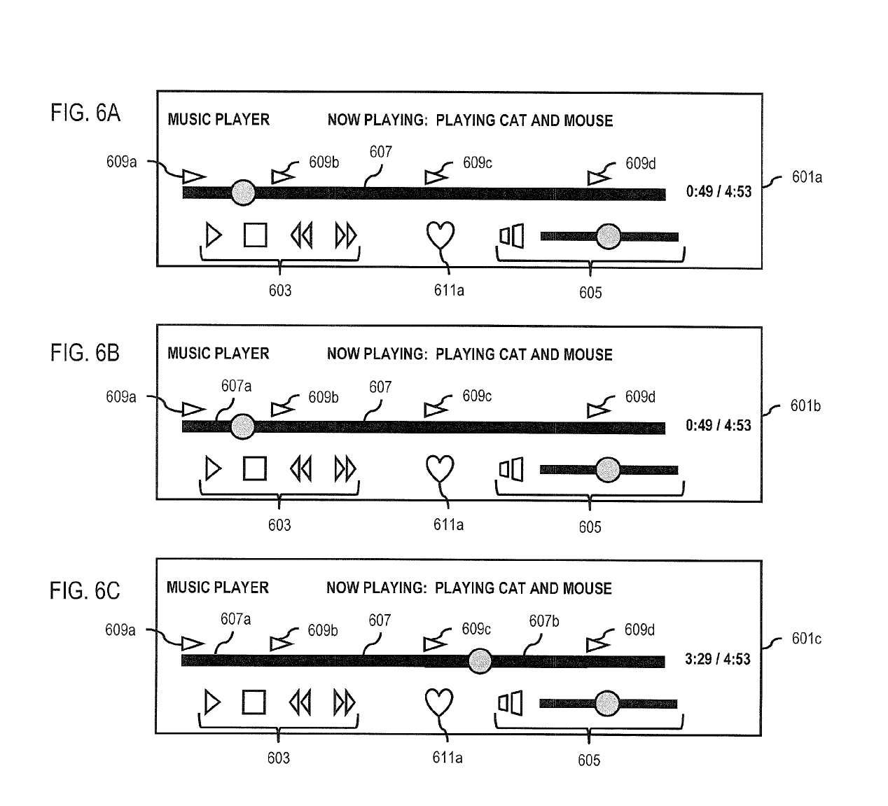

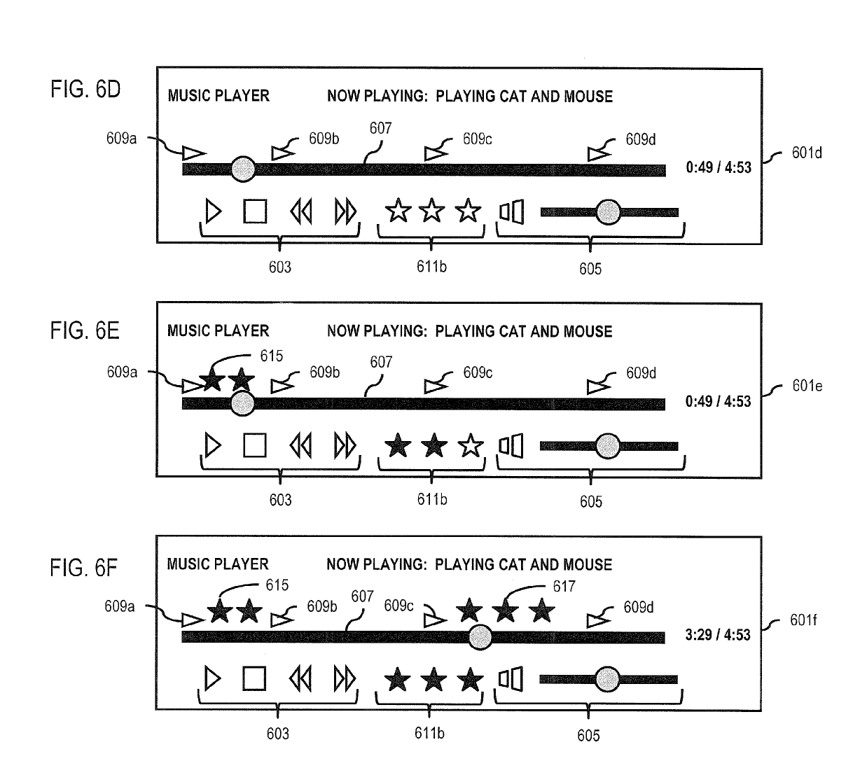

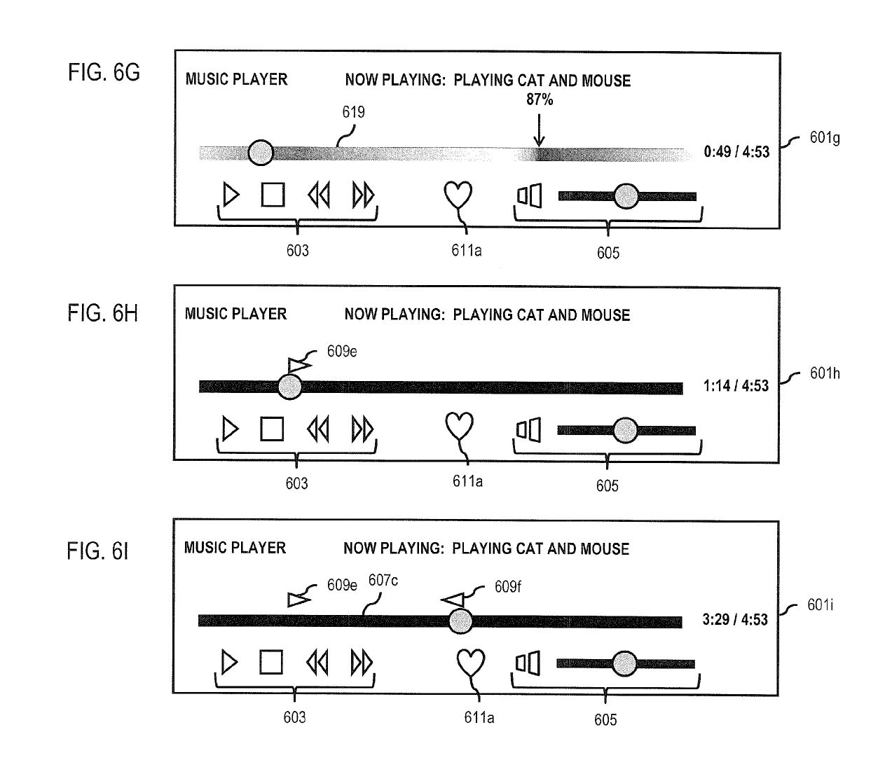

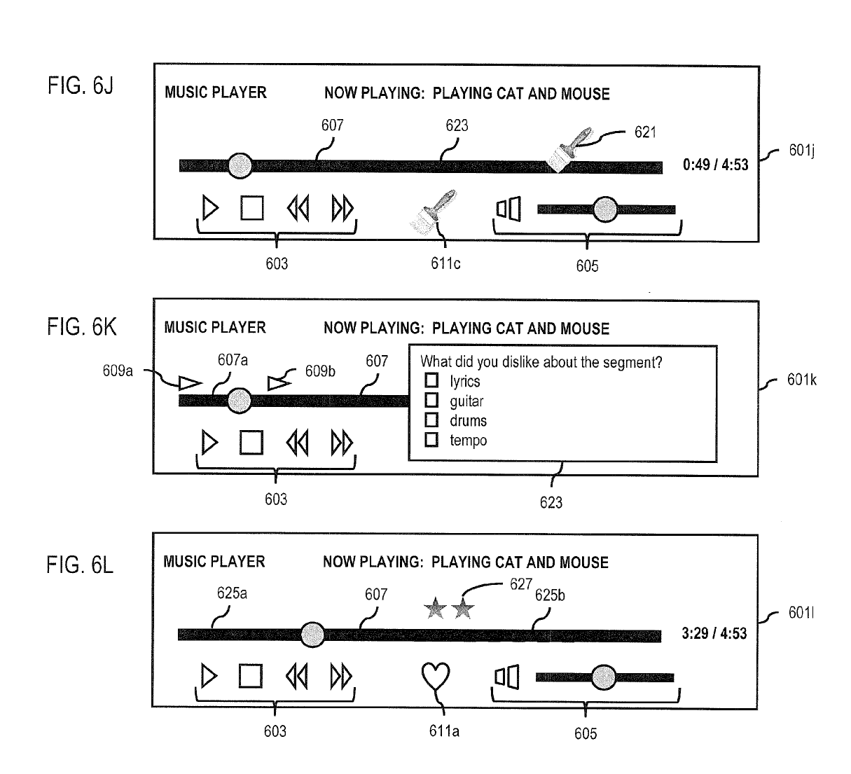

The user interface module 211 may provide information with respect to the content items and/or segments of the content items to modify user interfaces associated with the content items. For example, where an application 111a associated with the UE 101 is playing a content item, such as a song, the user interface module 211 may interface with the application 111a to provide information with respect to the song based on one or more segments of the song. For example, the user interface module 211 may provide information with respect to collaborative ratings associated with the song based on one or more segments of the song. The collaborative ratings may be presented, for example, by modifying the progress bar of the user interface associated with playback of the song. The user interface module 211 may also provide information to the application 111a regarding the rating information associated with the content item and/or segments of the content items to modify the user interface, as discussed in detail below with respect to FIGS. 6A through 61.

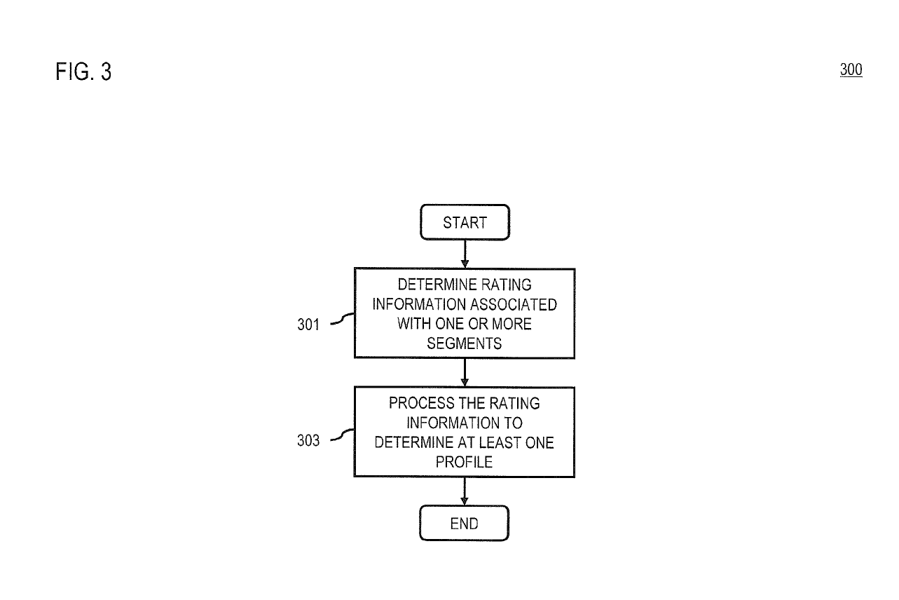

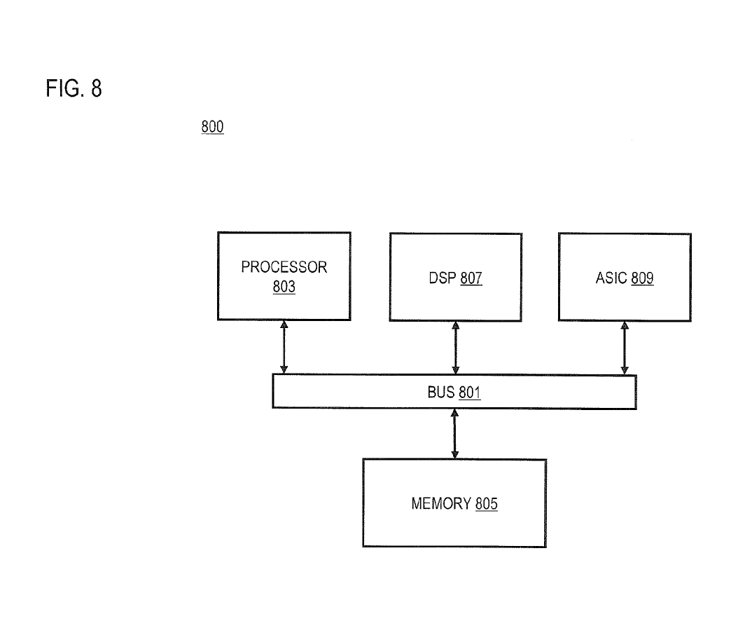

FIG. 3 is a flowchart of a process for determining user profiles with respect to content items based on segments of the content items, according to one embodiment. In one embodiment, the segment-based user profile platform 103 performs the process 300 and is implemented in, for instance, a chip set including a processor and a memory as shown in FIG. 8.

In step 301, the segment-based user profile platform 103 determines rating information associated with one or more segments of one or more content items corresponding to at least one user. As discussed above, the one or more segments are discrete portions of the one or more content items. By way of example, a content item may be a movie and a segment of the movie may be a thirty second portion of the movie, a scene in the movie, etc. Further, by way of example, a content item may be a song and a segment of the song may be the chorus of the song. In one embodiment, the song may be segmented according to, for example, one or more instruments that in combination with other instruments constitute the song.

The rating information may be any kind of information associated with a user liking and/or disliking one or more segments of the content items. As discussed above, and by way of example, the rating information may include a user indicating the he or she likes a segment. The rating information may also include the user providing a scaled rating, such as two stars out of three, 87 points out of 100, etc. The rating information may also include information indicating that a user dislikes the segment, in addition to a scaled rating of the dislike. In one embodiment, the absence of rating information for a segment may be ignored. Alternatively, the absence of rating information for a segment may indicate a neutral rating.

Next, in step 303, the segment-based user profile platform 103 processes the rating information to determine at least one user profile of the at least one user. The user profile is based on the rating information with respect to the one or more segments of the content items. Thus, the user profile is based on a higher granularity than conventional profiles that are based on content items as a whole. The user profile may be generated according to any method used to build a model from rating information provided by users, such as the principle component analysis discussed above. By way of example, the segment-based user profile platform 103 may determine matrices associated with the users and the content items that describe each based on later factors and perform analysis on these matrices to generate the user profiles. Accordingly, with the generated user profile, the segment-based user profile platform 103 may provide recommendations to users that are more tailored to the users' tastes and preferences.

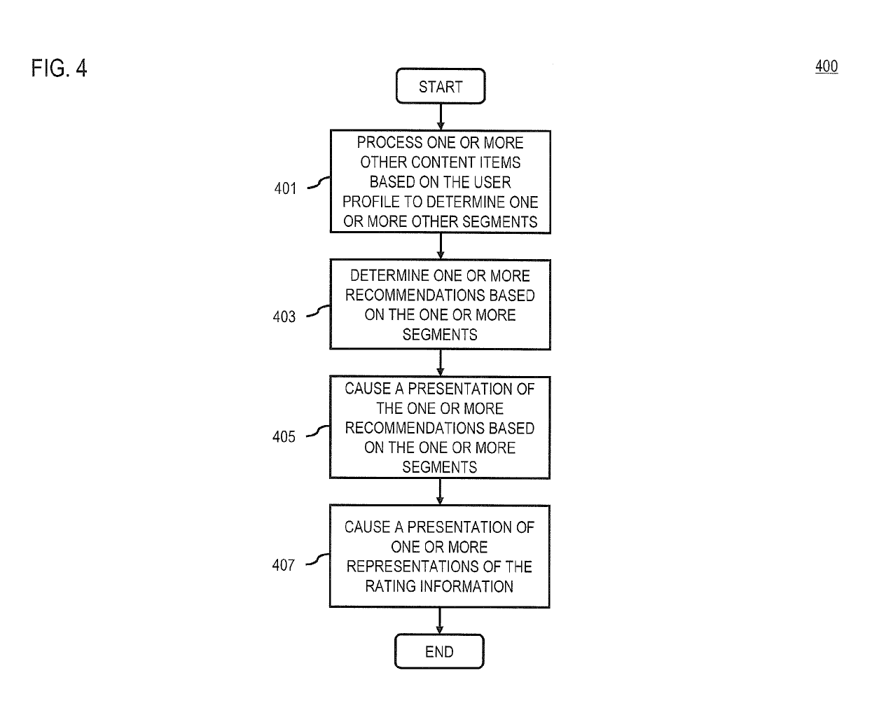

FIG. 4 is a flowchart of a process for providing one or more recommendations of content items based on the user profiles and one or more segments of the content items, according to one embodiment. In one embodiment, the segment-based user profile platform 103 performs the process 400 and is implemented in, for instance, a chip set including a processor and a memory as shown in FIG. 8.

In step 401, the segment-based user profile platform 103 processes one or more other content items based, at least in part, on the at least one user profile to determine one or more other segments of the one or more other content items. Like the one or more segments discussed above, the one or more other segments are discrete portions of the one or more other content items. The segment-based user profile platform 103 compares the properties of the user profile that was determined by analyzing the characteristics and properties of segments to one or more other segments. The analysis indicates the one or more other segments that are similar to the one or more segments that the user provided rating information for, and, therefore, determines one or more other segments of one or more other content items that the user may similarly enjoy.

Accordingly, in step 403, the segment-based user profile platform 103 determines one or more recommendations of the one or more other content items based, at least in part, on the one or more other segments that the segment-based user profile platform 103 determined from step 401 above. By way of example, where the content items are songs, the segment-based user profile platform 103 can determine one or more songs to recommend to the user based on determining songs with similar segments as the one or more segments that the user highly rated. By providing recommendations of songs on the basis of one or more segments of the songs, the segment-based user profile platform 103 can more accurately pin point the reason why user likes songs to provide more accurate recommendations.

In step 405, in one embodiment, the segment-based user profile platform 103 can cause, at least in part, a presentation of the one or more recommendations based, at least in part, on the one or more other segments. By presenting the one or more recommendations based, at least in part, on the one or more other segments, the segment-based user profile platform 103 allows a user to consume the one or more other segments to determine if they would enjoy the one or more other content items, rather than have to consume the entire other content items or a generic segment of the other content items. By way of example, where the recommendation pertains to recommending one or more songs to the user, the segment-based user profile platform 103 may, in one embodiment, generate or select segments of the songs that most closely match the segment of other songs that the user likes and present those selected segments. Thus, the user can immediately listen to the segments of the recommendations that the user should like the most to determine if the user likes the entire song.

In one embodiment, in step 407, the segment-based user profile platform 103 may cause, at least in part, a presentation of one or more representations of the rating information associated with the one or more other segments that are provided to the user as one or more recommendations. The segment-based user profile platform 103 may determine expected or predictive rating information associated with the one or more other segments based on the user profile and the properties and/or characteristics of the one or more other segments. Under this embodiment, a user may see visually why the one or more other segments were selected and recommended to the user. Further, in one embodiment, the segment-based user profile platform 103 allows for a user to modify the expected or predictive rating information, which can provide further rating information with respect to one or more segments of one or more content items that the segment-based user profile platform 103 can use to further refine and/or build the user profile.

In one embodiment, rather than presenting the one or more other segments of the one or more other content items directly, such as causing a song to play starting at a highly rated segment, the segment-based user profile platform 103 can visually represent the one or more other segments and the rating information associated with the segments. The content item can then be consumed from the beginning, such as from the beginning of the song, and the user can manually skip to the segments based on the visualizations of the rating information if the user does not want to listen to the entire song.

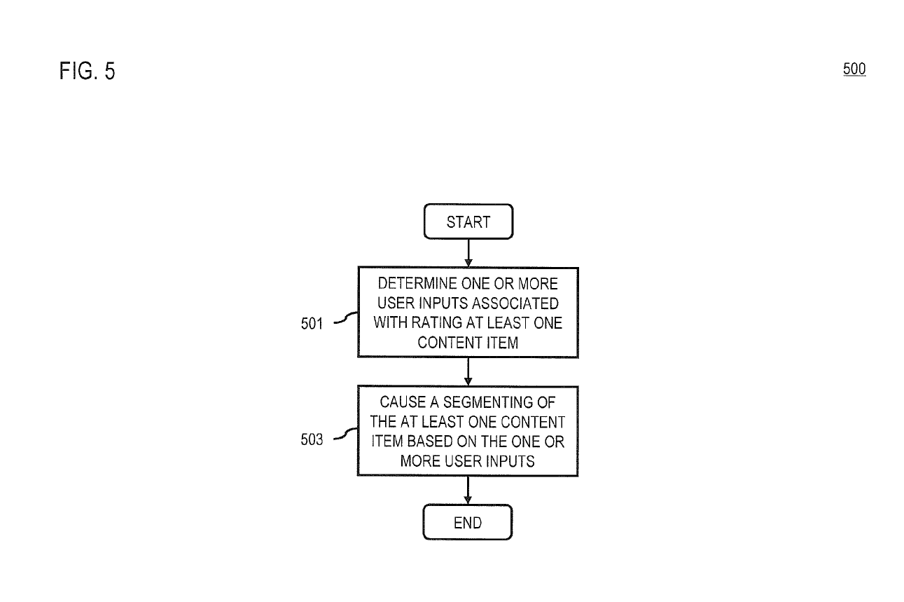

FIG. 5 is a flowchart of a process for determining one or more segments of a content item, according to one embodiment. In one embodiment, the segment-based user profile platform 103 performs the process 500 and is implemented in, for instance, a chip set including a processor and a memory as shown in FIG. 8.

In step 501, the segment-based user profile platform 103 determines one or more user inputs associated with rating at least one content item. The one or more user inputs may be associated with, for example, physical inputs (e.g., selecting a like button, accelerometer sensors, etc.), visual inputs (e.g., one or more gestures, etc.), audio inputs (e.g., voice commands, etc.), and the like. In one embodiment, one of the inputs may be clicking and holding down a like button. In one embodiment, one of the inputs may be clicking and releasing a like button. However, the one or more user inputs may be any type of user input that can provide rating information with respect to a segment of a content item.

In step 503, the segment-based user profile platform 103 causes, a least in part, a segmenting of the at least one content item based, at least in part, on the one or more user inputs. The one or more inputs thus can correspond to indicating a beginning, an ending, a length of time, or a combination thereof of at least one segment of the at least one content item. For example, a user may select a number of stars indicating rating information. Selecting the number of stars may constitute a user input that indicates the beginning of a segment of a content item. The user may subsequently select another button (e.g., stop rating button) to indicate an end of the segment. Based on the one or more user inputs, the segment-based user profile platform 103 may determine a segment of the at least one content item. Where the one or more inputs were associated with providing rating information, the segment-based user profile platform 103 may also associate the rating information with the newly generated segment.

In one embodiment, to accommodate a delay that may occur between the user beginning to like a portion of a song that is playing and causing one or more inputs to begin marking a section of the song, the segment-based user profile platform 103 may determine an indication of a beginning of at least one segment of at least one content item based, at least in part, on at least on threshold period of time prior to the one or more user inputs. The threshold period of time may specify, for example, that the beginning of the segment occurs five, ten, fifteen, etc. seconds prior to the user indicating the beginning based on an input. This allows for a user to properly mark the beginning of a segment of a content item the user wants to rate without having to immediately indicate the rating and the beginning, thus accounting for a delay in the user's reaction.

FIGS. 6A-6L are diagrams of user interfaces utilized in the processes of FIGS. 3-5, according to various embodiments. FIG. 6A illustrates a user interface 601a of a music player application 111a. The user interface 601a may include one or more control buttons 603 that allow for starting and/or stopping playback of a song, for example, in addition to the volume control indicator 605 that allows for controlling the volume of the song. The user interface 601a may include a progress bar 607 (as illustrated by the thick line, circle and time indicator) that indicates the current location within the song that is playing. The progress bar 607 may include one or more segment indicators 609a-609d that indicate the number and position of the segments of the song that is playing. As illustrated, the current song that is playing includes four segments. The four segments may be created automatically by the segment-based user profile platform 103 based on an acoustic analysis of the song. Further, the user interface 601a may include a like button 611a that allows a user to indicate his or her interest in the current segment of the song that is playing. Although the like button is illustrated as a heart, as discussed above, the like button 611a may be any shape and may include one or more additional buttons (e.g., multiple stars, smiley faces, etc.).

As illustrated by the user interface 601b in FIG. 6B, while a song is playing, a user may indicate their rating with respect to the segment associated with the location of the song that is currently playing by selecting the like button 611a. Selection of the like button 611a indicates that the user likes the current segment of the song. In response to this input, the user interface 601b may indicate the rating by displaying the highlighted portion 607a within the progress bar 607. Although the indication is illustrated by way of a shade of gray, the illustration may be based on any visual indication. Further, as illustrated by the user interface 601c in FIG. 6C, the user may provide additional rating information with respect to another segment of the currently playing song at the current point of playback, as illustrated by the highlighted portion 607b. Accordingly, based on the rating information provided by the user with respect to the currently playing song, the segment-based user profile platform 103 can provide a user profile and/or update a user profile to determine one or more other segments of one or more other content items, such as songs, that the user may similarly enjoy.

FIG. 6D illustrates a user interface 601d of a music player application 111a. The user interface 601d may include a like button 611b that allows a user to indicate his or her interest in the current segment of the song that is playing by rating the segment according to one, two or three stars. As illustrated by the user interface 601e in FIG. 6E, while a song is playing, a user may indicate their rating with respect to the present segment of the song by selecting the like button 611b and a number of stars to associate with the segment, such as two stars. In response to this input, the user interface 601e may indicate the rating by displaying two stars 615 in the progress bar 607. Further, as illustrated by the user interface 601f in FIG. 6F, the user may provide additional rating information with respect to another segment of the currently playing song at the current point of playback, as illustrated by the three stars 617. Accordingly, based on the rating information provided by the user with respect to the currently playing song, the segment-based user profile platform 103 can provide a user profile and/or update a user profile to determine one or more other segments of one or more other content items, such as songs, that the user may similarly enjoy.

Adverting to FIG. 6G, the user interface 601g may provide visualization to a user with respect to compiled rating information for one or more segments associated with a content item. Thus, the user interface 601g may include a gradient progress bar 619 that corresponds to compiled rating information such that, for example, the darker portions of the progress bar 619 indicate higher ratings for the song according to rating information of individual segments provided by other users, and the lighter portions of the progress bar 619 indicate lower ratings for the song according to the rating information. Further, in one embodiment, the user may select a portion of the progress bar 619, as illustrated by the arrow and 87% indicator, to see a quantitative value for the rating information with respect to the selected portion.

FIG. 6H illustrates a user interface 601h associated with a user manually generating a segment for a content item. By way of example, a user may be listening to a song and determine that he or she likes the current part of the song that is playing. The user may select like button 611a to indicate that they like song that is playing starting at the current time of the playback. A segment indicator 609e may appear to indicate the beginning of the segment as indicated by the user. As discussed above, the beginning of the segment may correspond to the time of the playback of the song when the user selects the like button 611a, or may correspond to a threshold period of time before the user selects the like button 611a. Further, as illustrated by the user interface 601i in FIG. 6I, when the user selects the like button 611a again (or when the user releases the like button 611a) the user interface 601i may include a segment indicator 609f indicating the ending of the segment of the song that the user likes. Thus, by selecting the like button 611a, the user can both generate a segment of the song and provide rating information of the song. The user interface 601i may also include a highlighted portion 607c indicating that the user provided rating information regarding the segment of the song.

FIG. 6J illustrates a user interface 601j of a music player application 111a as illustrated in, for example, FIG. 6A, however, the user interface 601j may include a paintbrush icon 611c that allows a user to indicate his or her interest in a segment of a content item by swiping or painting the segment of the content item the user likes. For example, upon the user selecting the paintbrush icon 611c, a paintbrush cursor 621 may become active and allow the user to brush the segment of the progress bar 607 that the user likes, as indicated by the highlighted portion 623 of the progress bar 607. Further, the paintbrush icon 611c may start blinking or change colors upon the user selecting the paintbrush icon 611c.

As illustrated by the user interface 601k in FIG. 6K, while a song is playing a user may decide to skip the song and/or indicate a dislike associated with a segment of the song. For example, the user may select the forward icon associated with the control buttons 603 if the user does not like the segment associated with the highlighted portion 607a of the progress bar 607. In response, the segment-based user profile platform 103 may generate a menu 623 that includes one or more questions to determine why the user does not like the segment of the content item. By way of example, the menu 623 may inquire about characteristics the user did not like regarding a song, such as the lyrics, guitar, drums or the tempo of the song. Based on the user's response to the menu 623, the segment-based user profile platform 103 may update the user profile and may dynamically recommend another content item based on the user's answers.

FIG. 6L illustrates a user interface 601l of a music player application 111a as illustrated in, for example, FIG. 6A. However, the user interface 601l may include one or more recommended segment indicators 625a and 625b within the progress bar 607. The one or more recommended segment indicators 625a and 625b allow the user to visually comprehend within the progress bar 607 the one or more segments that the segment-based user profile platform 103 determined as recommended segments for the user. The user may then preview or consume the one or more recommended segments and provide rating information for the segments. In one embodiment, the user interface 601l may further include one or more predicted rating indicators 627 associated with the one or more recommended segments, such as by being near the recommended segment indicator 625b. The one or more predicted rating indicators 627 may be the predicted rating information associated with the recommended segment as determined by the segment-based user profile platform 103 based on the user profile for the user currently listening to the content item. The user may then adjust or confirm the predicted rating information after the user previews or consumes the recommended segment.

The processes described herein for determining user profiles with respect to content items based on segments of the content items may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

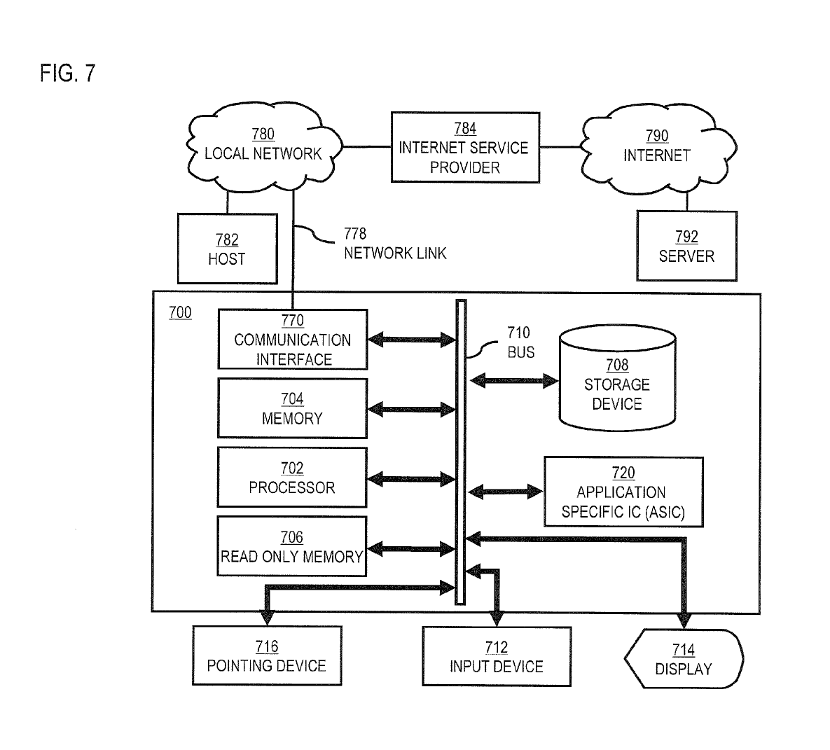

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to determine user profiles with respect to content items based on segments of the content items as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of determining user profiles with respect to content items based on segments of the content items.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to determining user profiles with respect to content items based on segments of the content items. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for determining user profiles with respect to content items based on segments of the content items. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for determining user profiles with respect to content items based on segments of the content items, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for determining user profiles with respect to content items based on segments of the content items and providing one or more recommendations based on the user profiles at the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to determine user profiles with respect to content items based on segments of the content items as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of determining user profiles with respect to content items based on segments of the content items.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to determine user profiles with respect to content items based on segments of the content items. The memory 805 also stores the data associated with or generated by the execution of the inventive steps.

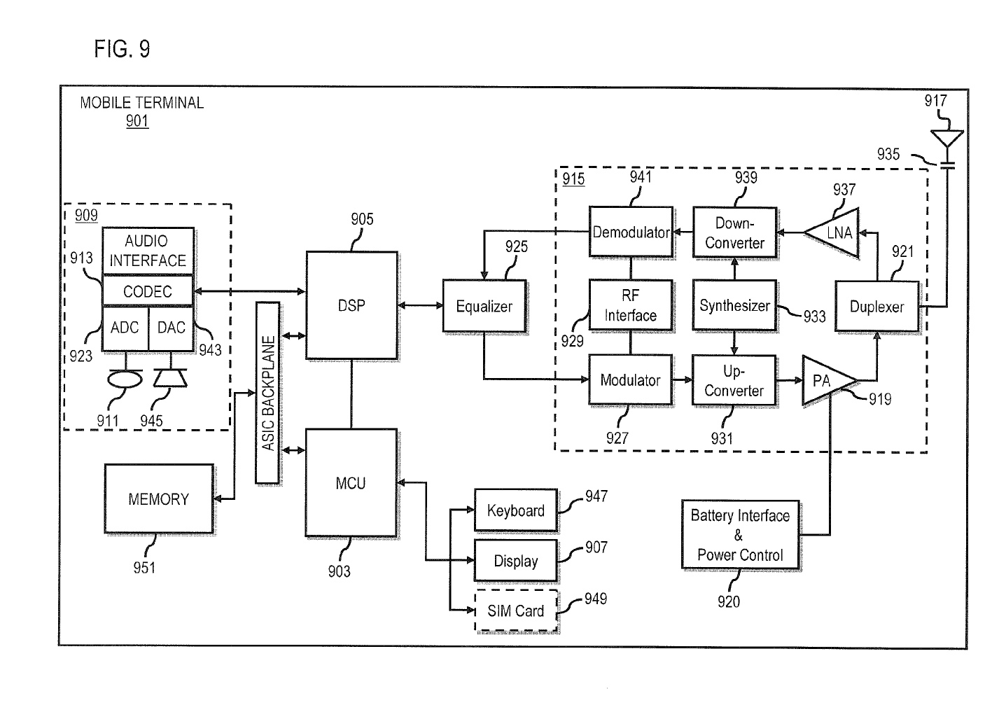

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of determining user profiles with respect to content items based on segments of the content items. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of determining user profiles with respect to content items based on segments of the content items. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to determine user profiles with respect to content items based on segments of the content items. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-20. (canceled)

21. A method comprising:
determining rating information associated with one or more segments of one or more content items corresponding to at least one user, wherein the one or more segments are discrete portions of the one or more content items; and
processing and/or facilitating a processing of the rating information to determine at least one user profile of the at least one user.

22. A method of claim 21, further comprising:
processing and/or facilitating a processing of one or more other content items based, at least in part, on the at least one user profile to determine one or more other segments of the one or more other content items, wherein the one or more other segments are discrete portions of the one or more other content items; and
determining one or more recommendations of the one or more other content items based, at least in part, on the one or more other segments.

23. A method of claim 22, further comprising:
causing, at least in part, a presentation of the one or more recommendations based, at least in part, on the one or more other segments.

24. A method according to claim 21, further comprising:
causing, at least in part, a presentation of one or more representations of the rating information associated with the one or more segments that visualizes the one or more segments within the one or more content items.

25. A method according to claim 22, further comprising:
causing, at least in part, a combination of at least two of the one or more other segments into at least one new content item based, at least in part, on the one or more recommendations, one or more user selections of the one or more other segments, or a combination thereof.

26. A method according to claim 22, further comprising:
determining compiled rating information associated with the one or more segments of the one or more content items corresponding to a plurality of users; and
processing and/or facilitating a processing of the compiled rating information to determine one or more characteristics of the one or more segments.

27. A method according to claim 21, further comprising:
determining one or more user inputs associated with rating at least one content item of the one or more content items; and
causing, at least in part, a segmenting of the at least one content item based, at least in part, on the one or more user inputs.

28. A method of claim 27, wherein the one or more user inputs indicate a beginning, an ending, a length of time, or a combination thereof of at least one segment of the at least one content item and rating information associated with the at least one segment.

29. A method of claim 28, further comprising:
determining an indication of a beginning of at least one segment of the at least one content item based, at least in part, on at least one threshold period of time prior to the one or more user inputs.

30. A method of claim 29, further comprising:
determining one or more other user inputs associated with the at least one segment; and
causing, at least in part, a tagging of the at least one segment item based, at least in part, on the one or more other user inputs.

31-38. (canceled)

39. An apparatus comprising:
at least one processor; and
at least one memory including computer program code for one or more programs,
the at least one memory and the computer program code configured to, with the at least one processor, cause the apparatus to perform at least the following,
determine rating information associated with one or more segments of one or more content items corresponding to at least one user, wherein the one or more segments are discrete portions of the one or more content items; and
processing and/or facilitating a processing of the rating information to determine at least one user profile of the at least one user.

40. An apparatus of claim 39, wherein the apparatus is further caused to:
process and/or facilitate a processing of one or more other content items based, at least in part, on the at least one user profile to determine one or more other segments of the one or more other content items, wherein the one or more other segments are discrete portions of the one or more other content items; and
determine one or more recommendations of the one or more other content items based, at least in part, on the one or more other segments.

41. An apparatus of claim 40, wherein the apparatus is further caused to:
cause, at least in part, a presentation of the one or more recommendations based, at least in part, on the one or more other segments.

42. An apparatus of claim 39, wherein the apparatus is further caused to:
cause, at least in part, a presentation of one or more representations of the rating information associated with the one or more segments that visualizes the one or more segments within the one or more content items.

43. An apparatus of claim 40, wherein the apparatus is further caused to:
cause, at least in part, a combination of at least two of the one or more other segments into at least one new content item based, at least in part, on the one or more recommendations, one or more user selections of the one or more other segments, or a combination thereof.

44. An apparatus of claim 40, wherein the apparatus is further caused to:
determine compiled rating information associated with the one or more segments of the one or more content items corresponding to a plurality of users; and
process and/or facilitate a processing of the compiled rating information to determine one or more characteristics of the one or more segments.

45. An apparatus of claim 39, wherein the apparatus is further caused to:
determine one or more user inputs associated with rating at least one content item of the one or more content items; and
cause, at least in part, a segmenting of the at least one content item based, at least in part, on the one or more user inputs.

46. An apparatus of claim 45, wherein the one or more user inputs indicate a beginning, an ending, a length of time, or a combination thereof of at least one segment of the at least one content item and rating information associated with the at least one segment.

47. An apparatus of claim 46, wherein the apparatus is further caused to:
determine an indication of a beginning of at least one segment of the at least one content item based, at least in part, on at least one threshold period of time prior to the one or more user inputs.

48. An apparatus of claim 47, wherein the apparatus is further caused to:
determine one or more other user inputs associated with the at least one segment; and
cause, at least in part, a tagging of the at least one segment item based, at least in part, on the one or more other user inputs.
